(19) United States
(12) Patent Application Publication
(10) Pub. No.: US 2018/0053271 A1
(43) Pub. Date: Feb. 22, 2018

(54) SYSTEM, METHOD AND COMPUTER PROGRAM PRODUCT FOR LICENSE ALLOCATION IN A MULTI-TENANT ENVIRONMENT

(71) Applicant: International Business Machines Corporation, Armonk, NY (US)

(72) Inventors: Ruchi MAHINDRU, Elmsford, NY (US); Valentina Salapura, Chappaqua, NY (US)

(21) Appl. No.: 15/243,496

(22) Filed: Aug. 22, 2016

(51) Int. Cl. G06Q 50/18

(52) U.S. Cl. CPC G06Q 50/184; G06Q 2220/18

(57) ABSTRACT

A license allocation method, system, and computer program product, include inserting and updating data in a license knowledge base about a plurality of license types and about a plurality of customers, querying the license knowledge base for used license data and unused license data associated with each of the plurality of customers, and assigning a license to or returning the license from a customer of the plurality of customers based on an action by the customer.

### BACKGROUND

The present invention relates generally to a license allocation system, and more particularly, but not by way of limitation, to a system, method, and computer program product for prediction of license usage/requirements based on historical data and a request/deals pipeline, swapping of licenses based on usage/prediction, and use of cross customer usage requirements to recommend swapping underutilized/non-compliant licenses.

In a multi-tenant cloud environment, customers may dynamically change their workload, which may make their licensing requirements fluid as well. For some customers this may lead to a non-compliant environment, and for others under-used licenses.

However, needs in the art include the needs to allow customers to return under-used licenses to a general license pool available for all customers and re-purchase them as needed, to allow swapping of licenses from one customer to another depending on the demand to optimize the license usage, and to keep the environments compliant and cost-effective.

### SUMMARY

In an exemplary embodiment, the present invention can provide a computer-implemented license allocation method including inserting and updating data in a license knowledge base about a plurality of license types and about a plurality of customers, querying the license knowledge base for used license data and unused license data associated with each of the plurality of customers, and assigning a license to or returning the license from a customer of the plurality of customers based on an action by the customer.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which

FIG. 1 exemplarily shows a block diagram illustrating a configuration of a license allocation system 100.

FIG. 2 exemplarily shows a high-level flow chart for a license allocation method 200 of a license optimization orchestrator 121.

FIG. 3 exemplarily shows a high-level flow chart for a license swapping of Step 206 of method 200.

FIG. 4 depicts a cloud computing node according to an embodiment of the present invention.

FIG. 5 depicts a cloud computing environment according to an embodiment of the present invention.

FIG. 6 depicts abstraction model layers according to an embodiment of the present invention.

### DETAILED DESCRIPTION

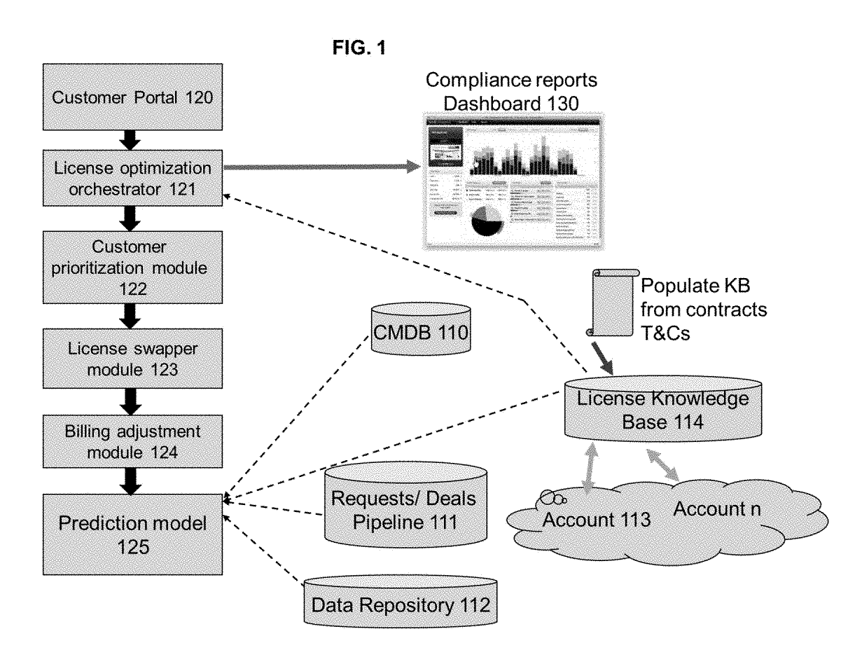

The invention will now be described with reference to FIG. 1-6, in which like reference numerals refer to like parts throughout. It is emphasized that, according to common practice, the various features of the drawing are not necessarily to scale. On the contrary, the dimensions of the various features can be arbitrarily expanded or reduced for clarity.

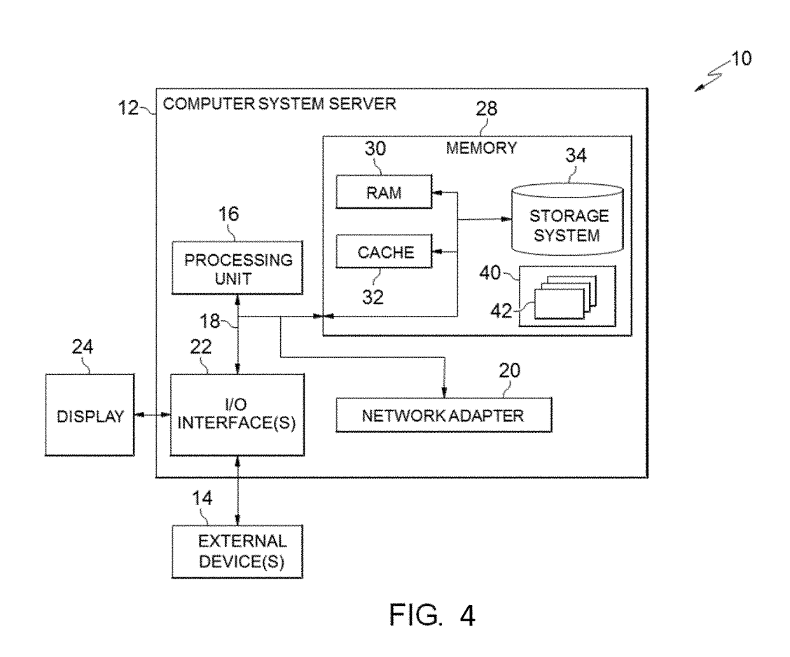

With reference now to the example depicted in FIG. 1, the license allocation system 100 includes various structural components to predict license usage/requirements based on historical data and request/deals pipeline (storing outstanding requests of new prospective customers), swap licenses based on usage/prediction, and monitor use of cross customer usage requirements to recommend swapping underutilized/non-compliant licenses. As shown in at least FIG. 4, one or more computers of a computer system 12 according to an embodiment of the present invention can include a memory 28 having instructions stored in a storage system to perform the functions of the components of FIG. 1.

Thus, the license allocation system 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

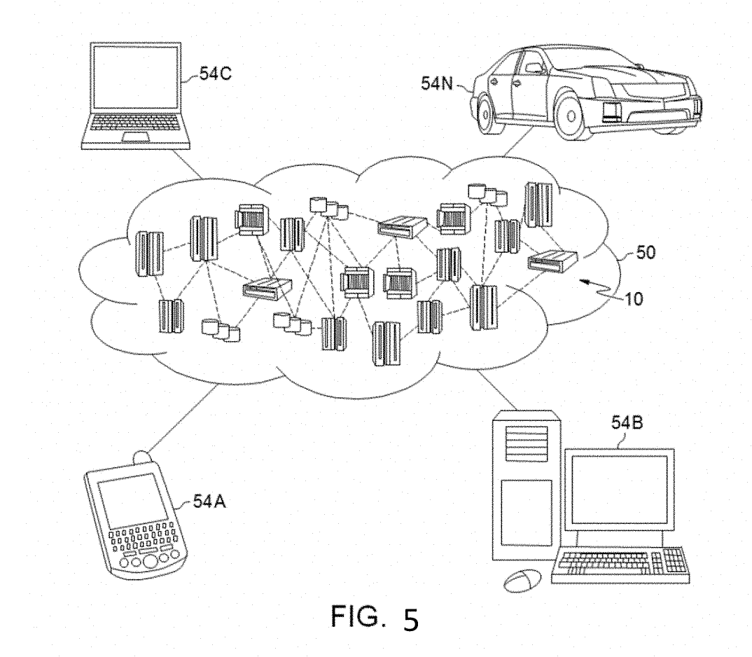

Although one or more embodiments (see e.g., FIGS. 4-6) may be implemented in a cloud environment 50 (see e.g., FIG. 5), it is nonetheless understood that the present invention can be implemented outside of the cloud environment.

A license knowledge base 114 is populated from the terms and conditions of contracts for licenses. The license knowledge base 114 may comprise, for example, customer data, license data, maximum limit on license reuse data, number of switches already performed data, expiration date data, license allocation start date, license allocation end date, system ID to which the license was allocated, status of the license data for each account 113 to account n (where “n” is an integer). That is, data is inserted and updated in the license knowledge base 114.

The license knowledge base 114 manages and keeps track of licenses between multiple customer accounts, their expiration, maximum number of reuse allowed, and the number of times the license was used. It is noted that a license knowledge base 114 is provided for each of the account n such that there is a one to one mapping with each account n.

A license optimization orchestrator 121 queries the license knowledge base 114 to extract data needed for prediction, swapping, billing adjustment needed by by a prediction model 125, license swapper module 123, and by a billing adjustment module 124, respectively. Thus, the license optimization orchestrator 121 queries the license knowledge base 114 about used and unused licenses and customers associated therewith it and assigns or returns a license to/from a customer.

The license optimization orchestrator 121 can assign a license to a customer from the account 113 pool of available licenses, assign a license to a customer from a pool of dummy accounts 113 (e.g., unassigned licenses available for the account 113), return a license to an available license pool for the same account, and/or return a license to an available license pool for other accounts (to a placeholder account). A placeholder customer account is not an actual customer account but rather it is used to track the available licenses which can be allocated to actual customers requiring it.

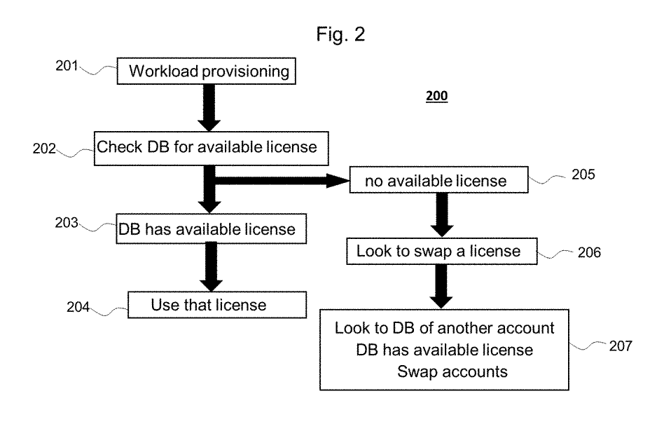

With reference now to the example depicted in FIG. 2, the license allocation method 200 of the license optimization orchestrator 121 can assign or return licensees.

In step 201, jobs can be defined in the customer portal 120 for workload provisioning.

In step 202, the license knowledge base 114 (e.g., DB in FIG. 2) is checked for available licenses for the jobs needing to be executed by the customer for their account.

In step 203, an availability of the license to execute the jobs is determined for the license knowledge base 114, and the license is used in step 204 if the license is available.

If it is determined that there is not an availability of the license to execute the jobs in step 205, the license swapper module 123 looks to swap a license in step 206 from a different server within the same customer account.

Alternatively, in step 207, if the license knowledge base 114 of another account has available licenses, the license swapper module 123 swaps the licenses being unused by the another account to the customer on the account requesting the license for the job.

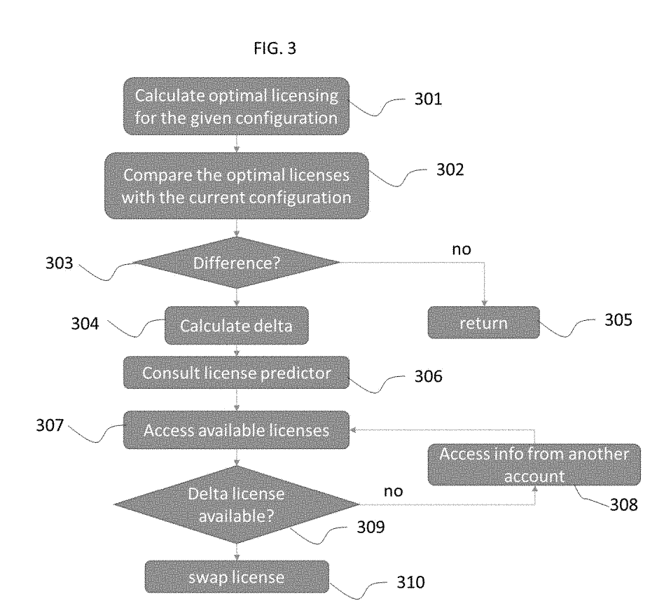

Referring now to FIG. 3, an exemplary license swap method flow is described based on the license swapper module 123 looking to swap a license in step 206.

In step 301, an optimal licensing for the given configuration (e.g., according to the account) is calculating. In step 302, the optimal licenses is compared with the current configuration of the account. In step 303, it is determined if there is a difference between the optimal license configuration and the current configuration. If no, in step 305 the method ends. If there is a difference, the difference between the optimal license configuration and the current configuration is calculated in step 304. In step 306, the license predictor is consulted. In step 307, the access to available licenses is determined (e.g., according to the license optimization orchestrator 121 and the prediction model 125). In step 309, if the change is available to swap to the optimal license, the license is swapped in step 310. If “no”, then in step 308 information or data from another account is accessed to determine if the license may be available.

In some embodiments, a new customer may request a license for the first time for a job (existing or new license). The license optimization orchestrator 121 identifies whether there is a license available in the license knowledge base 114 that is requested by the customer. If the license is available in the environment and if license is available through an existing customer or available pool, the license optimization orchestrator 121 can assign a license from the available pool that is assigned to a placeholder customer and update the license knowledge base 114 with the new customer data, number of switches data, and status data as ‘Reserved’. In addition, the license optimization orchestrator 121 can assign a license from the available pool that is assigned to an existing customer and update the license knowledge base 114 with new customer data, number of switches data, and status data as ‘Reserved’. Selection of the existing customer pool from which to allocate the license to the new customer is performed based on priority, detailed in a later section. Based on the new customer using a license for the first time, the billing adjustment module 124 starts billing the customer for the usage of the license.

In some embodiments, an existing customer may request a license. The license optimization orchestrator 121 checks the license knowledge base 114 if the requesting customer already has the license assigned to them but the customer may be requesting additional quantity that is available. The license optimization orchestrator 121 assigns an additional quantity of the license from the available pool for the customer or assigns a license from the available pool for the placeholder customer.

In some embodiments, a customer may return licenses to the pool of available licenses but the customer does not leave the environment. The license is still associated with the existing customer but the license optimization orchestrator 121 updates the license knowledge base 114 to set that the license is available for request by any customer, a number of switches is not increased, and the status data is set to ‘AVAILABLE’. That is, the license optimization orchestrator 121 sets that the license is available to be requested by any customer and the billing adjustment module 124 adjusts the billing such that the license is not being charged to the original customer while it is sitting in the license knowledge base 114 as ‘AVAILABLE’. Further, the customer prioritization module 122 sets the priority to the original customer, if they request it to optimize the number of switches. The license optimization orchestrator 121 returns the license to the license knowledge base 114 and the billing adjustment module 124 adjusts the billings so that the customer is no longer charged for the unused license.

In some embodiments, the customer may return a license and leave the environment. The license optimization orchestrator 121 updates the license knowledge base 114 and licenses that are not allocated to any customer are assigned to a placeholder customer as “AVAILABLE”. Also, the license optimization orchestrator 121 can trigger for a discount for customers to return licenses to the service provider based on the available pool size and prospective requests/deals pipeline 111. This is to suffice a shortage that may happen if majority or all of the prospective requests are submitted and the number of available licenses in the available pool is insufficient to satisfy such requests.

The license optimization by the license optimization orchestrator 121 further consults with the customer prioritization module 122 to determine which customer takes priority if the licenses are limited. The customer prioritization module 122 can prioritize customers for licensing based on rules. Such rules can be defined based on input from the customer, a number of specific type of workloads, an importance of the workload based on its type (e.g., production versus non-production), a license cost and the amount of licenses the customer has, (e.g. Oracle DB on Windows® may get priority), and a customer workload pool. For example, if a customer has a large cluster of servers in their environment, the cluster size can be downgraded temporarily (because the cluster may be seasonal) and instead the license can be issued to another workload that may be going live for first time or has higher priority based on the criteria above. That is, the customer prioritization module 122 can prioritize assignment of licenses to customers based on the importance of their workload as determined from the customer portal 120. Also, a warning can be issues when a license is under used so that the customer is not charged if they do not wish to be.

Similarly, a customer with higher service level agreement (SLA) can be prioritized higher as compared to another customer with lower SLA. .

The license optimization orchestrator 121 can further provide reports to a compliance system (e.g., compliance reports dashboard 130) to provide early warnings on when the license pool may be reaching its capacity. Additionally, the compliance report can provide early warnings if a customer becomes (or may become) non-compliant.

In some embodiments, the license swapper module 123 can swap the licenses between virtual machines or customers and the billing adjustment module 124 adjusts the billing.

In some embodiments, the license optimization orchestrator 121 consults with a prediction model 125 to determine the amount of licenses which will be needed and the structure of the licenses in the demand configuration management databases (CMDBs) 110 that should be kept available to meet ongoing customer demands

In some embodiments, the prediction model 125 can predict the number of licenses that may be needed over a period of time based on learning from historical data of the data repository 112.

In some embodiments, the prediction model 125 can predict whether the existing license will be requested by a same customer based on a length of usage or based on a historical usage of the data repository and a likelihood of the request from the same customer from the requests/deals pipeline 111. This is important to as it allows the system to optimize the number of license switches.

In some embodiments, the prediction model 125 can predict whether new licenses will be requested by an existing customer based on a pattern of the customers workload and how often the customer switches workloads in a steady state.

In some embodiments, the prediction model 125 can predict whether a license will be requested by a new customer based on how often a new customer comes into the environment and request available or new licenses according to the new account interaction with the license knowledge base 114.

In some embodiments, the prediction model 125 can predict if an account may become non-compliant based on individual customer predictions, compiling the overall system view, and alerts when the prediction falls below available licenses threshold.

Thereby, the system 100 can predict license usage/requirements based on historical data and request/deals pipeline, swap licenses based on usage/prediction, and monitor use of cross customer usage requirements to recommend swapping underutilized/non-compliant licenses.

Exemplary Aspects, using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail) The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 4, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 5, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 5 are intended to be illustrative only and that computing nodes 10 and cloud computing environment 50 can communicate with any type of computerized circuit over any type of network and/or network addressable connection (e.g., using a web browser).

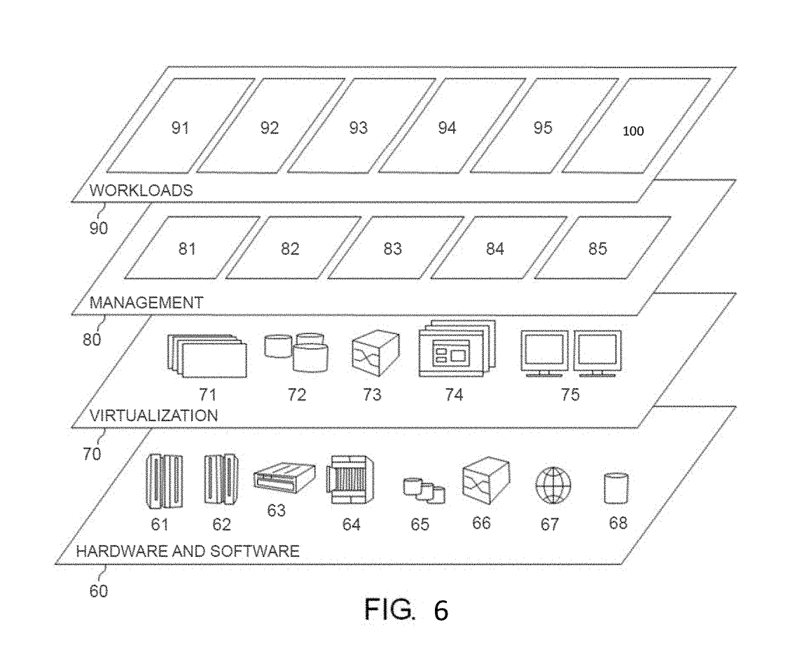

Referring now to FIG. 6, an exemplary set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the license allocation system 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented license allocation method, the method comprising:
inserting and updating data in a license knowledge base about a plurality of license types and about a plurality of customers;
querying the license knowledge base for used license data and unused license data associated with each of the plurality of customers; and
assigning a license to, or returning the license from, a customer of the plurality of customers based on an action by the customer.

2. The computer-implemented method of claim 1, wherein the assigning assigns the license to the customer from a pool of available licenses owned by the customer.

3. The computer-implemented method of claim 1, wherein the assigning assigns the available license to the customer from a pool of placeholder customer.

4. The computer-implemented method of claim 1, wherein the assigning returns a license to an available license pool for the customer when the action of the customer returns the license.

5. The computer-implemented method of claim 1, wherein the assigning returns a license to an available license pool for other customers when the action of the customer returns the license.

6. The computer-implemented method of claim 1, wherein the assigning prioritizes assigning the license to the customer based on an importance of a workload of the customer as compared to a workload of another customer requesting the license.

7. The computer-implemented method of claim 1, wherein a billing to the customer for the allocated license is adjusted based on when the license is assigned and when the license is returned by the action of the customer.

8. The computer-implemented method of claim 1, further comprising providing a first warning before a license pool for the plurality of licenses reaches a capacity and a second warning if a customer is non-compliant based on the data in the license knowledge base.

9. The computer-implemented method of claim 8, wherein the first warning is provided when a number of the used licenses is within a predetermined threshold value of a number of the licenses in the license pool.

10. The computer-implemented method of claim 1, further comprising swapping the license between virtual machines and/or between the customer and another customer.

11. The computer-implemented method of claim 1, further comprising predicting a number of licenses for a pool of the plurality of licenses required over a period of time based on learning from historical data of a data repository.

12. The computer-implemented method of claim 1, further comprising predicting if the license for the customer will be requested again by the customer based on a length of use and a likelihood of the request from the same customer.

13. The computer-implemented method of claim 1, further comprising predicting if a new license will be requested by the customer based on a pattern of the customer's workload and a number of times the customer switches workloads in a steady state.

14. The computer-implemented method of claim 1, further comprising predicting if a license will be requested by a new customer based on how often the new customer enters into an environment and requests the license according to an interaction with the license knowledge base.

15. The computer-implemented method of claim 1, embodied in a cloud-computing environment.

16. A computer program product for license allocation, the computer program product comprising a computer readable storage medium having program instructions embodied therewith, the program instructions executable by a computer to cause the computer to perform:
inserting and updating data in a license knowledge base about a plurality of license types and about a plurality of customers;
querying the license knowledge base for used license data and unused license data associated with each of the plurality of customers; and
assigning a license to, or returning the license from, a customer of the plurality of customers based on an action by the customer.

17. The computer program product of claim 16, wherein the assigning assigns the license to the customer from a pool of available licenses owned by the customer.

18. The computer program product of claim 16, wherein the assigning assigns the license to the customer from a pool of dummy customer-unassigned licenses.

19. A license allocation system, said system comprising:
a processor; and
a memory, the memory storing instructions to cause the processor to:
insert and update data in a license knowledge base about a plurality of license types and about a plurality of customers;
query the license knowledge base for used license data and unused license data associated with each of the plurality of customers; and
assign a license to, or return the license from, a customer of the plurality of customers based on an action by the customer.

20. The system of claim 19, embodied in a cloud-computing environment.
